(19) United States
(12) Patent Application Publication
(10) Pub. No.: US 2026/0291995 A1
(43) Pub. Date: Sep. 24, 2026

(54) PEER-TO-PEER ENDPOINT MANAGEMENT SYSTEM AND METHOD FOR DECENTRALIZED DEVICE SECURITY AND ORCHESTRATION

(71) Applicant: Ahum Inc, Foster City, CA (US)

(72) Inventor: Rahul Chander Kashyap, Foster City, CA (US)

(73) Assignee: Ahum Inc, Foster City, CA (US)

(21) Appl. No.: 19/681,141

(22) Filed: May 19, 2026

(51) Int. Cl. H04L 9/40

(52) U.S. Cl. CPC H04L 63/20; H04L 63/0428; H04L 63/1441

(57) ABSTRACT

The present disclosure relates to a method for decentralized device management and security orchestration across a peer-to-peer mesh network. The method includes deploying a plurality of endpoint agents on corresponding endpoint devices to perform one or more of device discovery, inventory tracking, vulnerability scanning, threat detection, and patch orchestration. The method further includes coordinating communication among the endpoint agents within the mesh network, establishing and maintaining consistency and compliance through consensus validation, and allocating operational tasks based on compute power, resource availability, network bandwidth, and priority. The method applies artificial intelligence models to detect anomalies, identify malware signatures, prioritize patches, and generate remediation recommendations. The method also enables bandwidth-aware synchronization, verifies adherence to enterprise policies, and initiates automated remediation upon detecting non-compliance. The disclosed method maintains operational continuity and coordinated defense even during network disconnection, providing fault-tolerant, autonomous, and bandwidth-efficient endpoint management.

### BACKGROUND

### Technical Field

The present invention relates to the field of endpoint management and cybersecurity systems. More particularly, the invention pertains to a peer-to-peer mesh-based method and system for decentralized device management, security orchestration, and compliance enforcement across distributed endpoint devices.

### Description of the Related Art

Modern endpoint management architectures are predominantly built on centralized client-server frameworks, where a single management console communicates with numerous endpoint devices to perform administrative and security operations. Such operations typically include software deployment, patch installation, compliance verification, and threat detection. However, as enterprise infrastructures expand across hybrid cloud environments, remote workstations, and mobile or IoT devices, these traditional centralized systems struggle to deliver the scalability, resilience, and responsiveness required for real-time endpoint management.

A key limitation of conventional architectures lies in their dependency on continuous connectivity to a central server. When endpoints lose network access or operate in low-bandwidth environments, they become temporarily unmanageable, unable to receive updates, report telemetry, or enforce compliance policies. This causes operational blind spots and security vulnerabilities, as critical patches or threat responses are delayed until connectivity is restored. In large-scale deployments, the centralized model also becomes a bottleneck, introducing latency during concurrent updates and placing excessive load on the core server infrastructure.

Furthermore, existing endpoint solutions are resource-heavy and rigid, employing monolithic agents that rely on frequent synchronization with the management server. Such agents consume substantial computing resources on endpoints, leading to degraded performance, especially in constrained environments. Since these architectures follow a unidirectional flow of data, where telemetry must be sent upstream for analysis and decisions flow downstream, there is little autonomy or intelligence at the edge. This dependency makes organizations vulnerable to downtime, data loss, and delayed threat mitigation during network interruptions or server failures.

From a cybersecurity standpoint, centralized architectures are reactive rather than proactive. Threat detection models are maintained centrally, meaning that endpoints cannot leverage local insights or collaborative intelligence to identify anomalies. As a result, malicious behavior on one endpoint is often detected only after the central system processes aggregated data, by which time other endpoints may already be compromised. Additionally, continuous transmission of telemetry data to the server not only increases bandwidth consumption but also raises privacy and regulatory concerns, as sensitive operational data frequently leaves its originating device.

These limitations underscore the need for a new generation of endpoint management frameworks that eliminate single points of failure, minimize latency, and empower endpoints to operate autonomously. There exists a strong requirement for a system and method that enable peer-to-peer cooperation among endpoints, allowing them to distribute tasks, share intelligence locally, and collectively enforce security and compliance even in disconnected or degraded networks. Such an architecture should be self-healing, adaptive, and bandwidth-efficient, integrating local AI inference and distributed consensus to ensure continuity of defense and compliance without relying on centralized orchestration. The present invention addresses these challenges through a peer-to-peer mesh-based endpoint management and security orchestration framework, enabling fully decentralized, intelligent, and resilient operation across distributed devices.

The reference to any prior art in this specification is not an acknowledgment or suggestion that prior art forms part of the common general knowledge in any jurisdiction or that a person skilled in the art could reasonably expect that prior art to be understood, regarded as relevant, and/or combined with other aspects of the prior art.

### BRIEF SUMMARY

The present invention provides a peer-to-peer endpoint management framework configured for decentralized device management, security orchestration, and compliance enforcement across distributed computing environments. The invention overcomes the limitations of traditional centralized architectures by enabling endpoint devices to operate collaboratively through a mesh-based network, where each device contributes both as an operational node and as a decision-making entity. This design removes the dependency on a single control server, thereby ensuring operational continuity, adaptability, and resilience even under network disruptions or partial infrastructure failures. In one embodiment, the invention provides a peer-to-peer endpoint management system comprising a plurality of endpoint agents deployed across endpoint devices. Each endpoint agent is configured to perform one or more of device discovery, vulnerability analysis, patch orchestration, and threat detection while also acting as an orchestrator for local and cooperative tasks. The system includes functional modules such as an agent orchestration module for coordinating communication among peers, a consensus engine for maintaining consistency and compliance, a task distribution module for allocating operational tasks based on resource availability, a security intelligence module utilizing artificial intelligence for anomaly detection and remediation, a bandwidth optimization module for peer synchronization, and a compliance management module for enforcing enterprise security policies. The system further includes a communication interface configured for encrypted peer-to-peer exchanges of task data, threat intelligence, and compliance information.

In another embodiment, the invention provides a method for decentralized device management and security orchestration across a peer-to-peer mesh network. The method includes deploying endpoint agents across endpoint devices, coordinating peer communication, validating compliance through consensus, and distributing operational tasks based on real-time network and resource conditions. The method further includes applying AI-driven intelligence for threat identification, patch prioritization, and remediation recommendations. The method also enables offline autonomous operation, bandwidth-aware patch synchronization, and cooperative learning among peer agents to maintain coordinated defense and compliance during network interruptions or server outages. The proposed framework offers significant advantages over conventional endpoint management systems. It ensures fault tolerance, autonomous operation, and real-time adaptability through decentralized intelligence and distributed task orchestration. By minimizing server dependency, optimizing bandwidth consumption, and facilitating localized decision-making, the invention achieves resilient, scalable, and privacy-preserving endpoint management suitable for modern enterprise, hybrid, and edge computing environments.

An embodiment of the present invention discloses a peer-to-peer endpoint management system configured for decentralized device management and security orchestration. The system may comprise a plurality of endpoint agents, each deployed on a respective endpoint device and configured to perform one or more of: device discovery, inventory tracking, vulnerability scanning, threat detection, and patch orchestration. Each of the endpoint agents may operate as an independent execution entity capable of collecting local telemetry, analyzing system configurations, identifying potential threats, and coordinating patch deployment. The plurality of endpoint agents may collectively form a distributed mesh structure wherein each agent contributes to the overall operational intelligence of the system. The system may include an agent orchestration module configured to coordinate communication among the plurality of endpoint agents within a peer-to-peer mesh network. The agent orchestration module may establish and maintain logical peer connections, assign local tasks, and exchange performance metrics or operational states among the endpoint agents. In some embodiments, each endpoint agent may be operable as both a task sensor, responsible for collecting event data and reporting system conditions, and an orchestrator node, capable of initiating or delegating management tasks to other peers within the network. This dual functionality enables distributed intelligence and eliminates dependency on a central management server.

The system may further comprise a consensus engine configured to establish and maintain consistency and compliance among the plurality of endpoint agents by validating task execution, synchronizing operational results, and enforcing predefined security or configuration policies across the mesh network. The consensus engine may facilitate multi-agent agreement on task outcomes, ensure uniform enforcement of enterprise rules, and verify integrity of peer data before synchronization. This distributed consensus process ensures that every endpoint agent operates according to consistent policies, even in partial network partitions or intermittent connectivity conditions. The system may include a task distribution module configured to allocate operational tasks among the plurality of endpoint agents based on one or more of: compute power, resource availability, network bandwidth, and operational priority. The task distribution module may evaluate the processing capability of each endpoint, assess current workload and communication latency, and dynamically assign responsibilities such as scanning, patching, or validation to appropriate peers. The intelligent distribution of workloads allows the system to optimize performance and maintain balanced utilization of resources across the mesh network. In an embodiment, the system may comprise a security intelligence module configured to apply artificial intelligence models for one or more of: detecting anomalies, identifying malware signatures, prioritizing patches, and generating remediation recommendations based on cooperative peer data. The security intelligence module may execute local inference models on each endpoint, leveraging device telemetry and peer-shared insights to predict vulnerabilities and identify threats in real time. In some embodiments, the security intelligence module may perform federated learning among peers, allowing model updates and improvements to propagate through the network without sharing sensitive raw data, thereby preserving privacy and reducing bandwidth overhead.

The system may include a bandwidth optimization module configured to enable bandwidth-aware peer synchronization during software update and patch orchestration operations. The bandwidth optimization module may monitor network congestion, evaluate available throughput between peers, and schedule or throttle data transfer to minimize contention. The module may further ensure that patch files or update packages are propagated efficiently through peer-to-peer distribution rather than relying solely on centralized downloads. This functionality improves scalability and ensures reliable patch management even under constrained network conditions. The system may comprise a compliance management module configured to continuously verify adherence to enterprise security and configuration policies, and to initiate automated remediation upon detection of non-compliant states. The compliance management module may monitor endpoint configurations, analyze compliance reports, and trigger corrective actions such as enforcing configuration baselines, disabling unauthorized applications, or deploying mandatory updates. The distributed operation of this module allows compliance verification and remediation to occur autonomously across all endpoints without requiring real-time connectivity to a centralized controller.

The system may further comprise a communication interface configured to facilitate encrypted peer-to-peer exchanges of task data, threat intelligence, and compliance information between the plurality of endpoint agents. The communication interface may employ secure authentication and encryption protocols to ensure integrity and confidentiality of data transmitted within the mesh. In some embodiments, the communication interface may implement zero-trust access principles, allowing authenticated and verified peers to exchange information without reliance on a centralized certificate authority. In operation, the peer-to-peer endpoint management system may be operable to maintain operational continuity and coordinated defense across the plurality of endpoint devices even during network disconnection or server outages. The system's decentralized design enables each endpoint to execute its assigned functions, synchronize state upon reconnection, and maintain compliance autonomously. Through distributed intelligence, resource-aware orchestration, and fault-tolerant communication, the system provides a self-healing, adaptive, and bandwidth-efficient endpoint management framework that ensures sustained protection and performance across complex and distributed computing environments.

An embodiment of the present invention discloses a method for decentralized device management and security orchestration across a peer-to-peer mesh network. The method may include deploying a plurality of endpoint agents on corresponding endpoint devices, each configured to perform one or more of: device discovery, inventory tracking, vulnerability scanning, threat detection, and patch orchestration. The endpoint agents may be initialized with configuration data defining their operational roles and may register within the mesh network to establish peer connectivity. Each endpoint agent may thereby act as both a sensor node for collecting telemetry data and an orchestrator node for initiating or delegating management tasks across peers. The method may include coordinating communication among the plurality of endpoint agents within the peer-to-peer mesh network. This may involve discovery of active peers, exchange of capability descriptors, and maintenance of communication channels for continuous task synchronization. Each endpoint agent may communicate directly with other peers through encrypted channels, enabling decentralized coordination without reliance on a central management server. The method may further include establishing and maintaining consistency and compliance among the endpoint agents by validating task execution, synchronizing results, and enforcing policies through a distributed consensus process. The consensus mechanism ensures uniform enforcement of enterprise rules and coordinated behavior of endpoints, even in scenarios of intermittent connectivity or partial mesh partitioning.

The method may further include allocating operational tasks among the plurality of endpoint agents based on one or more of: compute power, resource availability, network bandwidth, and operational priority. The task allocation may be determined dynamically using a scheduling algorithm that evaluates each endpoint's performance parameters and assigns responsibilities accordingly. The method may also include applying artificial intelligence models for detecting anomalies, identifying malware signatures, prioritizing patches, and generating remediation recommendations using cooperative peer data. Each endpoint may execute local inference models while sharing aggregated threat intelligence or anonymized metadata to improve accuracy and collective awareness. In one embodiment, the method may include enabling bandwidth-aware peer synchronization during software update and patch orchestration operations. The synchronization frequency and data transfer rate may be adapted based on network congestion levels and available bandwidth thresholds to ensure efficient propagation of updates. The method may further include verifying adherence to enterprise security and configuration policies, and initiating automated remediation upon detection of non-compliant states. Such remediation may involve reconfiguration, patch deployment, or isolation of affected endpoints, executed autonomously at the edge. The method may also include facilitating encrypted peer-to-peer exchanges of task data, threat intelligence, and compliance information to ensure secure and verifiable collaboration across peers.

In a further embodiment, the method may include performing majority-vote consensus validation among endpoint agents to resolve task conflicts, and employing a machine-learning-based scheduling algorithm trained on historical device metrics to optimize subsequent task distribution. The method may also include executing federated learning among endpoint agents to continuously improve local AI models without transferring raw telemetry data, thereby preserving privacy and minimizing bandwidth consumption. In some cases, each endpoint agent may operate in an offline autonomous mode, caching task queues, compliance policies, and security updates locally for execution during network outages and resynchronization upon restoration of connectivity. Accordingly, the disclosed method enables distributed intelligence, cooperative defense, and adaptive orchestration across endpoint devices. By leveraging peer-to-peer coordination, AI-driven decision-making, and consensus-based compliance enforcement, the method ensures fault-tolerant, autonomous, and bandwidth-efficient endpoint management. The decentralized execution of security and operational functions minimizes server dependency and ensures consistent protection across all endpoints, even in dynamic, large-scale, and intermittently connected environments.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment of a peer-to-peer endpoint management system, in accordance with an embodiment of the present disclosure.

FIG. 2 illustrates a block diagram of the peer-to-peer endpoint management system, in accordance with an embodiment of the present disclosure.

FIG. 3 illustrates a functional workflow representing an exemplary process for security intelligence operations performed across endpoint agents within a mesh network, in accordance with an embodiment of the present disclosure.

FIG. 4 illustrates a functional workflow depicting an exemplary process for compliance management and patch orchestration across peer devices, in accordance with an embodiment of the present disclosure.

FIG. 5 illustrates a flowchart of an exemplary AI-driven task allocation method for dynamically distributing operational tasks among endpoint agents, in accordance with an embodiment of the present disclosure.

FIG. 6 illustrates a flowchart of an exemplary self-healing and offline operation method enabling autonomous recovery and synchronization within the mesh network, in accordance with an embodiment of the present disclosure.

FIG. 7 illustrates a flowchart of an exemplary method for decentralized endpoint management and security orchestration, in accordance with an embodiment of the present disclosure.

FIG. 8 illustrates an exemplary computing architecture in which or with which a peer-to-peer endpoint management system may be implemented, in accordance with an embodiment of the present disclosure.

Other features of embodiments of the present disclosure will be apparent from accompanying drawings and detailed description that follows.

### DETAILED DESCRIPTION

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Certain exemplary embodiments of the present invention are described below and illustrated in the accompanying figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art and all such alternate embodiments, modifications, and improvements are within the scope of the present invention.

According to common practice, the various features of the drawings discussed below are not necessarily drawn to scale. Dimensions of various features and elements in the drawings may be expanded or reduced to more clearly illustrate the embodiments of the invention.

The present invention provides a peer-to-peer endpoint management framework configured for decentralized device management, security orchestration, and compliance enforcement across distributed computing environments. The invention overcomes the limitations of traditional centralized architectures by enabling endpoint devices to operate collaboratively through a mesh-based network, where each device contributes both as an operational node and as a decision-making entity. This design removes the dependency on a single control server, thereby ensuring operational continuity, adaptability, and resilience even under network disruptions or partial infrastructure failures. In one embodiment, the invention provides a peer-to-peer endpoint management system comprising a plurality of endpoint agents deployed across endpoint devices. Each endpoint agent is configured to perform one or more of device discovery, vulnerability analysis, patch orchestration, and threat detection while also acting as an orchestrator for local and cooperative tasks. The system includes functional modules such as an agent orchestration module for coordinating communication among peers, a consensus engine for maintaining consistency and compliance, a task distribution module for allocating operational tasks based on resource availability, a security intelligence module utilizing artificial intelligence for anomaly detection and remediation, a bandwidth optimization module for peer synchronization, and a compliance management module for enforcing enterprise security policies. The system further includes a communication interface configured for encrypted peer-to-peer exchanges of task data, threat intelligence, and compliance information.

In another embodiment, the invention provides a method for decentralized device management and security orchestration across a peer-to-peer mesh network. The method includes deploying endpoint agents across endpoint devices, coordinating peer communication, validating compliance through consensus, and distributing operational tasks based on real-time network and resource conditions. The method further includes applying AI-driven intelligence for threat identification, patch prioritization, and remediation recommendations. The method also enables offline autonomous operation, bandwidth-aware patch synchronization, and cooperative learning among peer agents to maintain coordinated defense and compliance during network interruptions or server outages. The proposed framework offers significant advantages over conventional endpoint management systems. It ensures fault tolerance, autonomous operation, and real-time adaptability through decentralized intelligence and distributed task orchestration. By minimizing server dependency, optimizing bandwidth consumption, and facilitating localized decision-making, the invention achieves resilient, scalable, and privacy-preserving endpoint management suitable for modern enterprise, hybrid, and edge computing environments.

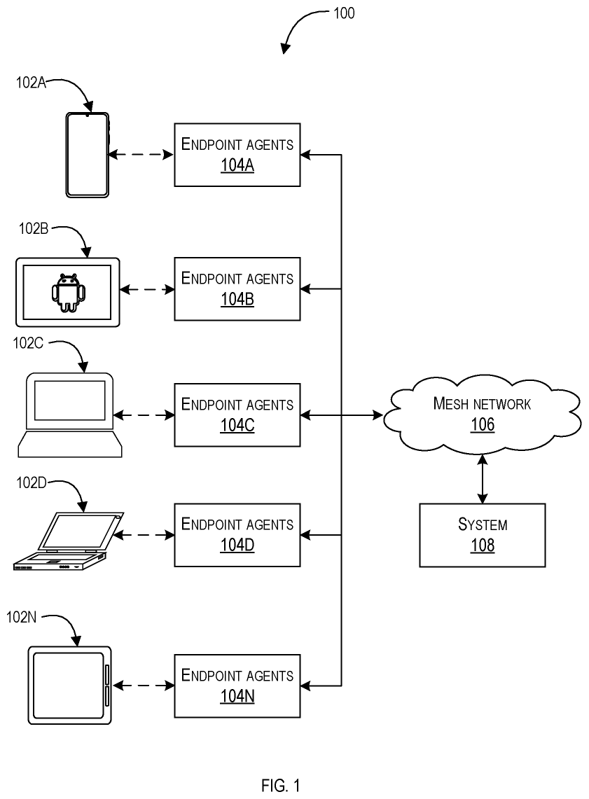

FIG. 1 illustrates an exemplary environment 100 of a peer-to-peer endpoint management system 108, in accordance with an embodiment of the present disclosure. The environment 100 may include a plurality of endpoint devices 102A-102N, each associated with one or more endpoint agents 104A-104N that are configured to perform decentralized management, monitoring, and security operations. The endpoint devices 102A-102N may represent any suitable computing devices, such as smartphones, tablets, laptops, desktops, embedded controllers, or enterprise edge devices capable of executing software agents.

Each of the endpoint agents 104A-104N may be deployed on a corresponding endpoint device and may be configured to perform device discovery, inventory tracking, vulnerability scanning, threat detection, and/or patch orchestration. The endpoint agents may operate autonomously to collect telemetry data, analyze local configurations, and initiate corrective or preventive actions based on device-specific states. Each endpoint agent 104 may further act as both a sensor node and an orchestrator node, thereby contributing actively to the collaborative operation of the peer-to-peer mesh network 106. The mesh network 106 may represent a logical interconnection of the endpoint agents 104A-104N, enabling peer-to-peer communication and coordination among endpoint devices 102A-102N without the necessity of a centralized management server. The mesh network 106 may support both wired and wireless communication protocols, including local area networks, enterprise intranets, or virtual private networks. The communication among peers may occur directly through encrypted channels, allowing each endpoint to share intelligence, exchange operational states, and synchronize task results. In some embodiments, the environment 100 may optionally include a system 108, which may function as an enterprise controller or cloud-based management layer for global configuration, analytics, and audit integration. The system 108 may communicate with the mesh network 106 through secure interfaces to provide high-level policy updates, configuration baselines, or federated model synchronization while maintaining the decentralized decision-making capabilities of individual endpoint agents. The system 108 may operate in a supervisory or optional analytics capacity, ensuring that overall enterprise governance is maintained without imposing a strict client-server dependency.

The peer-to-peer interconnection of endpoint devices 102A-102N through the mesh network 106 enables distributed orchestration of security and management operations. For example, when a vulnerability is detected by one endpoint agent, it may share the corresponding threat intelligence or patch data with nearby peers, allowing them to remediate proactively without awaiting central intervention. Similarly, task distribution within the mesh may be optimized based on device performance, connectivity status, and workload, ensuring efficient resource utilization and consistent compliance across the network. In operation, the environment 100 facilitates autonomous and fault-tolerant endpoint management. Even when network connectivity with the system 108 is interrupted, the mesh network 106 continues to function locally, allowing endpoint agents 104A-104N to execute assigned tasks, cache intermediate results, and later synchronize with the system 108 upon restoration of connectivity. This decentralized approach enhances resilience, reduces bandwidth consumption, and ensures that endpoint management functions such as patching, configuration enforcement, and threat mitigation continue uninterrupted across the enterprise network. Accordingly, the environment 100 demonstrates the overall distributed topology and interaction flow of the peer-to-peer endpoint management system 108. Through the combination of autonomous endpoint agents, mesh-based communication, and optional supervisory integration, the environment achieves scalable, secure, and self-healing endpoint management across diverse computing infrastructures.

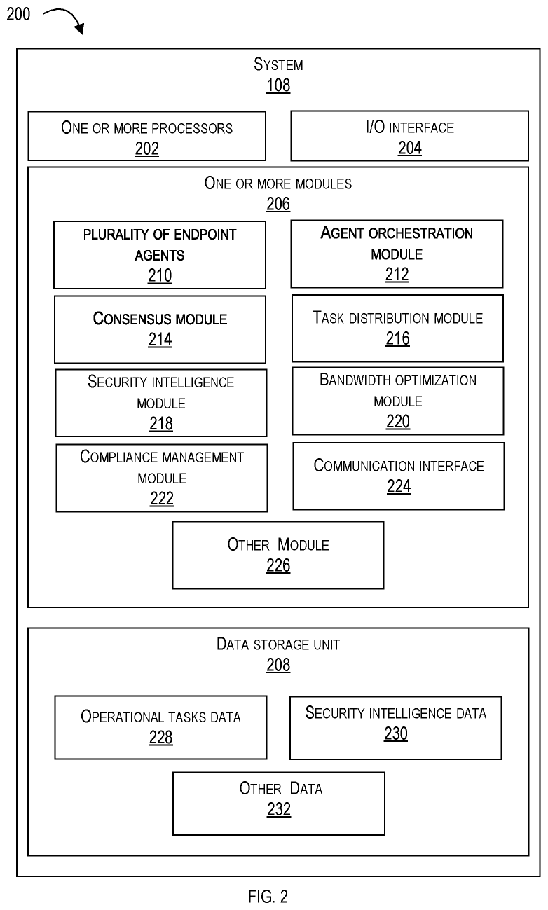

FIG. 2 illustrates a block diagram of the peer-to-peer endpoint management system 108, in accordance with an embodiment of the present disclosure. In an embodiment, the system 108 may include one or more processors 202, an Input/Output (I/O) interface 204, one or more modules 206, and a data storage unit 208. The one or more processors 202 may be implemented as one or more microprocessors, microcomputers, digital signal processors, central processing units, state machines, logic circuitries, and/or any electronic devices capable of executing machine-readable instructions. The processors 202 may be configured to execute program instructions stored within the memory to manage and control the overall operations of the system 108. The I/O interface 204 may serve as a bridge between internal processes of the system 108 and external environments, facilitating secure communication and data exchange between the system 108 and endpoint devices, applications, or external enterprise services. In certain embodiments, the I/O interface 204 may support data input through management consoles, application programming interfaces (APIs), or network communication channels, and may provide output through administrative dashboards, configuration utilities, or machine-to-machine exchanges. The I/O interface 204 may further enable encrypted communication across the peer-to-peer mesh network, allowing bidirectional data flow between the system 108, endpoint agents, and other authorized entities. The interface may support one or more wired or wireless communication protocols, including Ethernet, Wi-Fi, cellular, or secure VPN tunnels, and may facilitate transmission of management instructions, synchronization of configuration data, and reception of operational feedback from distributed endpoints.

In an embodiment, the one or more modules 206 may include, without limitation, a plurality of endpoint agents 210, an agent orchestration module 212, a consensus module 214, a task distribution module 216, a security intelligence module 218, a bandwidth optimization module 220, a compliance management module 222, a communication interface 224, and other modules 226. The one or more modules 206 may be implemented in hardware, software, firmware, or any suitable combination thereof, and may be operatively coupled to the one or more processors 202 and the data storage unit 208 to perform the functions of decentralized management, cooperative orchestration, and adaptive security enforcement. In an embodiment, the data storage unit 208 may include one or more databases configured to store information required for the operation of the system 108. Such information may include, without limitation, operational tasks data 228, security intelligence data 230, and other data 232 representing compliance records, configuration templates, and consensus logs. The data storage unit 208 may be implemented as static memory, dynamic memory, flash storage, or any other non-transitory computer-readable medium. In some embodiments, the data storage unit 208 may be locally integrated within the system 108 for on-premises operation, whereas in alternative embodiments it may be remotely hosted on a cloud infrastructure accessible via secure communication channels. In certain hybrid configurations, critical identifiers and encryption keys may be stored locally, while aggregated telemetry and model-training datasets may be maintained on distributed cloud repositories. The one or more processors 202 may be configured to orchestrate the operation of the one or more modules 206, regulate inter-module communication, and control the storage and retrieval of data within the data storage unit 208.

In an embodiment, the plurality of endpoint agents 210 may be deployed across a plurality of endpoint devices to collectively perform decentralized management, monitoring, and security orchestration functions within the peer-to-peer mesh network. Each endpoint agent 210 may operate as an autonomous software component configured to perform one or more of: device discovery, inventory tracking, vulnerability scanning, threat detection, and patch orchestration. The endpoint agents 210 may be executed on any computing platform capable of network communication, such as laptops, desktops, industrial controllers, mobile devices, or embedded IoT nodes. Each endpoint agent 210 may maintain its own local configuration, process telemetry data originating from the corresponding endpoint, and communicate selectively with neighbouring peers to propagate relevant operational information. In another embodiment, each endpoint agent 210 may act concurrently as both a sensor and an orchestrator node within the peer-to-peer mesh. As a sensor, the agent may collect endpoint-specific data, including hardware attributes, software state, configuration parameters, and detected anomalies. As an orchestrator node, the same agent may evaluate task assignments received through the mesh network, delegate subtasks to other peers based on resource availability, and validate the completion of distributed actions. This dual-role design enables the endpoint agents 210 to support fully decentralized decision-making without the need for a persistent central controller, thereby enhancing scalability and fault tolerance.

In some embodiments, the endpoint agents 210 may implement an internal intelligence layer configured to perform local inference and cooperative learning. Each agent may apply artificial-intelligence or rule-based models to identify behavioural anomalies, prioritise vulnerabilities, or recommend remediation actions. The endpoint agents 210 may periodically exchange abstracted threat intelligence, pattern signatures, or summary statistics with other peers through encrypted peer-to-peer channels. Such cooperative exchange allows the collective detection of emerging threats even when individual endpoints operate offline or intermittently connected. The architecture thus provides self-learning and adaptive behaviour across the distributed network, aligning with the inventive objective of autonomy described in the invention disclosure. In an embodiment derived from the invention disclosure, the plurality of endpoint agents 210 may further maintain resilience during offline conditions. When network connectivity is interrupted, each agent may continue executing locally assigned tasks, cache pending updates or compliance data, and re-synchronise upon network restoration. This capability ensures continuous security enforcement and system health monitoring irrespective of external connectivity. The endpoint agents 210 may additionally employ lightweight encryption, data compression, and intelligent caching mechanisms to optimise bandwidth consumption during peer synchronisation, reflecting the system's design for operational efficiency in bandwidth-limited environments.

In further embodiments, the plurality of endpoint agents 210 may be implemented as modular software containers, virtual machine processes, or firmware components embedded within managed hardware. Each agent may expose an interface supporting programmable extensions or plug-ins for additional functionalities such as device analytics, identity management, asset classification, or policy enforcement. The agent architecture may also accommodate hierarchical or hybrid deployments where certain agents assume temporary leadership or relay roles to optimise task routing and communication overhead. In alternative embodiments, the endpoint agents 210 may integrate with cloud-based analytics engines, edge gateways, or enterprise security information and event management (SIEM) systems to extend cross-domain coordination while preserving local autonomy. Accordingly, the plurality of endpoint agents 210 collectively form the foundation of the decentralized mesh ecosystem, providing adaptive, self-healing, and privacy-preserving endpoint management that enables the peer-to-peer endpoint management system 108 to function efficiently across heterogeneous and dynamic computing environments.

In an embodiment, the agent orchestration module 212 may be configured to coordinate communication and task execution among the plurality of endpoint agents within the peer-to-peer mesh network. The agent orchestration module 212 may enable each endpoint agent to act both as an initiating node and a receiving node for operational tasks, thereby supporting bidirectional orchestration without requiring a central server. The agent orchestration module 212 may dynamically maintain the topology of the mesh network, establish secure peer connections, and supervise message routing between endpoint agents. It may also synchronize task queues, event updates, and operational logs across active peers to ensure continuity of endpoint management operations. In another embodiment, the agent orchestration module 212 may employ a distributed coordination protocol that assigns orchestration roles based on network context and device capabilities. Each agent may periodically advertise its operational metrics, such as processor availability, memory status, and bandwidth, allowing the orchestration module 212 to elect or demote orchestrator nodes in real time. The agent orchestration module 212 may also monitor peer availability and automatically reassign orchestration responsibilities upon detecting network latency, device failure, or isolation. Through this mechanism, the system achieves self-healing coordination and uninterrupted management flow. As derived from the invention disclosure, the agent orchestration module 212 may facilitate autonomous coordination of security and compliance tasks across distributed endpoints. Instead of relying on linear task propagation from a central controller, the agent orchestration module 212 enables local decision-making where each orchestrator node aggregates peer feedback, validates execution results, and propagates verified updates further through the mesh. This decentralised control structure ensures that even under network partitioning or temporary disconnection, orchestration continues seamlessly within available peer clusters. The orchestration module 212 may additionally maintain a minimal transaction log, capturing orchestration outcomes and consensus confirmations for subsequent synchronization with supervisory systems.

In some embodiments, the agent orchestration module 212 may incorporate machine-learning-based orchestration logic to predict the optimal peer relationships and data-flow routes for efficient task execution. It may evaluate historical communication patterns, latency statistics, and prior task success rates to adaptively restructure peer clusters. This learning-driven orchestration allows the network to self-optimize for both performance and reliability. In further embodiments, the module 212 may employ federated orchestration techniques, where orchestration intelligence is partially distributed across multiple nodes, thereby balancing workload and preventing over-concentration of orchestration functions. In yet another embodiment, the agent orchestration module 212 may support hierarchical orchestration for large enterprise deployments. Under this configuration, multiple peer clusters may each elect a local orchestrator that coordinates intra-cluster activities while a higher-level orchestration layer synchronizes inter-cluster operations. The agent orchestration module 212 may ensure that all orchestration communications are secured through encryption and digital authentication protocols, thereby preserving confidentiality and integrity of operational commands. The module 212 may also expose an application programming interface (API) to integrate with third-party orchestration tools or enterprise monitoring platforms, allowing hybrid operation with existing IT management infrastructures.

In an embodiment, the consensus module 214 may be configured to establish and maintain consistency and compliance among the plurality of endpoint agents within the peer-to-peer mesh network. The module 214 may validate task execution, synchronize results, and enforce defined enterprise or security policies across all participating peers. Each endpoint agent may communicate its task outcome and operational status to neighbouring peers, and the consensus module 214 may reconcile any conflicts or discrepancies arising from asynchronous operations. The consensus process ensures that each endpoint maintains a uniform state, thereby achieving synchronized compliance across the distributed network without requiring central supervision. In another embodiment, the consensus module 214 may employ a multi-phase validation protocol wherein each peer contributes to a distributed verification process before a change or result is accepted as final. This may include proposal, validation, and commitment phases similar to consensus mechanisms used in distributed ledger systems, though optimized for lightweight endpoint environments. The consensus module 214 may assign validation weights to each peer based on resource reliability, trust score, or operational history, thereby improving the accuracy and resilience of the consensus process. The resulting uniformity guarantees that patch updates, configuration changes, and security remediations are simultaneously applied and acknowledged throughout the mesh network.

As described in the invention disclosure, the consensus module 214 may ensure policy consistency and cooperative integrity even during network fragmentation or offline operation. Each endpoint may locally cache the compliance state, execute its assigned task, and later reconcile differences once network connectivity is restored. The consensus module 214 may maintain a versioned ledger of task identifiers, execution timestamps, and validation records to detect conflicting or outdated actions. When multiple endpoints propose simultaneous updates, the consensus module 214 may resolve such conflicts based on deterministic rules or peer-majority voting. This process ensures that even in the absence of centralized authority, the distributed system converges toward a consistent and compliant operational state. In some embodiments, the consensus module 214 may incorporate artificial intelligence-driven anomaly evaluation to distinguish between benign deviations and potential malicious tampering during consensus validation. The consensus module 214 may analyze behavioural patterns, peer communication latency, and data irregularities to detect compromised nodes attempting to manipulate results. Upon detection, the module may isolate the suspected agent, flag the incident, and initiate network-level remediation procedures through the compliance management module 222. This enables a trust-aware consensus model, enhancing both security and operational reliability across the peer-to-peer ecosystem. In further embodiments, the consensus module 214 may support hierarchical or hybrid consensus architectures, depending on deployment scale. In smaller networks, a simple majority or two-phase commit mechanism may suffice, whereas in large enterprise or cloud-integrated configurations, the consensus module 214 may implement layered consensus where local clusters achieve intra-cluster agreement before propagating state to higher-tier aggregators. The consensus module 214 may further leverage cryptographic hashing to sign validation events, ensuring that all consensus transactions are traceable and immutable. In certain cases, the module may interface with blockchain or distributed ledger frameworks to externally audit compliance status across multi-tenant deployments.

In an embodiment, the task distribution module 216 may be configured to allocate operational tasks among the plurality of endpoint agents based on one or more of compute power, resource availability, network bandwidth, and operational priority. The consensus module 216 may continuously monitor system parameters associated with each endpoint, including processor utilization, memory consumption, network latency, and energy status. Using these parameters, the task distribution module 216 may dynamically assign, balance, or reassign workloads to ensure optimal utilization of distributed resources. The module may further determine task sequencing, grouping, and timing such that high-priority or security-critical actions receive preference over lower-impact maintenance operations. In another embodiment, the task distribution module 216 may function as a distributed scheduler, enabling peer-to-peer task propagation without reliance on a central controller. Each endpoint may advertise its operational state and capacity metrics through the mesh network, and the module 216 may use this data to determine the most suitable peer to execute a given task. The module may also prevent task redundancy by tracking task identifiers and maintaining execution logs across the network. In doing so, the task distribution module 216 ensures that identical scanning or patching tasks are not executed simultaneously by multiple peers, thereby conserving resources and reducing network load.

As described in the invention disclosure, the task distribution module 216 may utilize adaptive algorithms to identify and assign tasks based on real-time changes in endpoint conditions. For example, if an endpoint experience reduced bandwidth or elevated CPU usage, the module 216 may temporarily offload its queued tasks to neighbouring peers with higher resource availability. The module may also implement a predictive workload estimator that anticipates forthcoming spikes in processing demand, redistributing tasks before bottlenecks occur. This adaptive behaviour allows the distributed mesh network to remain responsive and balanced, ensuring continuous compliance and threat-response operations even in heterogeneous or fluctuating environments. In some embodiments, the task distribution module 216 may incorporate artificial intelligence-driven decision engines trained on historical execution data. These engines may identify optimal peer selection strategies, forecast completion times, and evaluate the reliability of individual endpoints. The task distribution module 216 may further employ reinforcement learning models that continuously refine allocation efficiency based on observed performance metrics. In scenarios of limited bandwidth, the module may combine its intelligence with the bandwidth optimization module 220 to delay or batch low-priority data transfers, achieving resource-aware orchestration across the peer-to-peer network.

In further embodiments, the task distribution module 216 may support multi-tier distribution policies suitable for enterprise-scale deployments. Under such configurations, the task distribution module 216 may partition endpoints into logical clusters, with local sub-orchestrators responsible for intra-cluster task scheduling and the higher-tier task distribution layer managing cross-cluster coordination. The module may provide configurable rule-sets defining execution priorities, dependency chains, and escalation procedures for incomplete or failed tasks. In another embodiment, the task distribution module 216 may allow manual overrides or policy-driven exceptions through administrative APIs, enabling integration with enterprise service management systems or third-party automation frameworks.

In an embodiment, the security intelligence module 218 may be configured to apply artificial-intelligence models for one or more of detecting anomalies, identifying malware signatures, prioritizing patches, and generating remediation recommendations based on cooperative peer data. The security intelligence module 218 may aggregate telemetry, behavioural, and event data received from the plurality of endpoint agents to perform a continuous security assessment. Using trained AI or heuristic models, the security intelligence module 218 may classify events as benign, suspicious, or malicious, and may generate corresponding confidence scores. It may further correlate these results with peer-reported findings to improve detection accuracy across the distributed mesh network. In another embodiment, the security intelligence module 218 may maintain a multi-layer analytics framework comprising a local inference layer and a federated aggregation layer. The local inference layer, operating on each endpoint, may analyse in-device telemetry to detect zero-day or behavioural threats without requiring cloud connectivity. The federated aggregation layer may periodically consolidate anonymised intelligence from multiple peers, enabling collaborative training of global detection models. This arrangement ensures that the peer-to-peer network evolves adaptively as threat landscapes change, while preserving data privacy.

As disclosed in the invention documentation, the security intelligence module 218 may be responsible for cross-peer anomaly detection and prioritised remediation. It may continuously evaluate vulnerability indices, patch criticality levels, and exploit likelihoods derived from cooperative endpoint analytics. Based on this evaluation, the security intelligence module 218 may recommend targeted remediation steps, such as deploying high-severity patches, isolating compromised peers, or adjusting firewall policies, ensuring that enterprise-wide protection is prioritised dynamically. The module may also integrate with the compliance management module 222 to verify post-remediation conformity to established policies. In some embodiments, the security intelligence module 218 may employ deep-learning-based classifiers trained on heterogeneous data, including network traffic features, process signatures, and historical incident metadata. These models may continuously self-update using federated learning methods, allowing distributed refinement without exposing sensitive endpoint information. The security intelligence module 218 may also leverage graph-based correlation models to uncover coordinated attack patterns or lateral movement attempts across multiple peers. Additionally, the module may interface with external threat-intelligence feeds, automatically incorporating new indicators of compromise into local and global model updates. In further embodiments, the security intelligence module 218 may support policy-driven AI orchestration, wherein detection thresholds, model selection, and retraining frequency are determined by enterprise risk appetite or operational policies. The module may expose APIs enabling administrators to tune model behaviour, import proprietary threat datasets, or export anonymised analytics to third-party security platforms. In some configurations, the security intelligence module 218 may be deployed at edge nodes or cloud aggregation points to balance inference latency and computational load. The module may also maintain encrypted caches of recently analysed events, enabling historical correlation and retrospective threat hunting.

In an embodiment, the bandwidth optimization module 220 may be configured to enable bandwidth-aware peer synchronization during software update and patch orchestration operations. The bandwidth optimization module 220 may monitor network utilization across the peer-to-peer mesh network and dynamically adjust data transfer parameters such as transmission rate, chunk size, and synchronization interval. The module may identify available bandwidth between endpoint agents, prioritize essential data exchanges, and defer non-critical transfers during periods of congestion. By intelligently managing synchronization workloads, the bandwidth optimization module 220 ensures efficient use of available network resources while maintaining continuous peer communication. In another embodiment, the bandwidth optimization module 220 may employ an adaptive throttling mechanism that dynamically regulates network load based on active traffic patterns. The module may continuously evaluate round-trip latency, packet loss, and throughput measurements to infer current network health. Upon detecting congestion or excessive latency, the bandwidth optimization module 220 may temporarily suspend or reschedule lower-priority updates, ensuring that high-severity patches or compliance data propagate without delay. Conversely, during idle bandwidth periods, the module may increase synchronization frequency or parallelize data transfers to accelerate overall system updates. As derived from the invention disclosure, the bandwidth optimization module 220 may further manage distributed patch dissemination through peer-to-peer caching and relay strategies. Instead of downloading updates individually from a central server, endpoint agents may obtain patch files from the nearest peer hosting the required version, thereby reducing external bandwidth consumption. The bandwidth optimization module 220 may maintain metadata tables identifying which peers possess specific update packages, allowing efficient routing of file requests. The module may also compress and segment patch data, enabling partial transmission and reassembly to further optimize bandwidth usage.

In some embodiments, the bandwidth optimization module 220 may include an AI-assisted prediction engine that anticipates network congestion based on historical usage patterns, time-of-day trends, or enterprise policy schedules. The bandwidth optimization module 220 may proactively reschedule update propagation or adjust synchronization paths to minimize conflicts with peak business hours. The bandwidth optimization module 220 may also interface with the task distribution module 216 to ensure that computationally intensive or data-heavy operations are delegated to peers with sufficient network capacity. This cooperative approach prevents bottlenecks and ensures even distribution of bandwidth load across the mesh. In further embodiments, the bandwidth optimization module 220 may support multi-channel and hybrid synchronization for large-scale enterprise environments. The module may concurrently utilize multiple communication pathways, such as Wi-Fi, cellular, or Ethernet, and dynamically shift traffic among them based on current throughput conditions. In some configurations, the bandwidth optimization module 220 may integrate with content delivery networks (CDNs) or cloud accelerators to offload patch delivery tasks while maintaining decentralized coordination within the peer network. Additionally, the module may perform checksum-based differential synchronization, transmitting only modified data segments rather than entire files, thus achieving substantial bandwidth savings.

In an embodiment, the compliance management module 222 may be configured to continuously verify adherence to enterprise security and configuration policies and to initiate automated remediation upon detection of non-compliant states. The compliance management module 222 may maintain a repository of compliance baselines, configuration templates, and control rules defining acceptable endpoint states. Each endpoint agent may periodically report its configuration parameters, patch level, and operational posture to the compliance management module 222, which may evaluate this information against predefined benchmarks. Upon detecting any deviation or violation, the module may automatically initiate corrective actions such as updating configuration files, reinstalling missing patches, or restricting network access for the affected endpoint. In another embodiment, the compliance management module 222 may implement a policy orchestration engine that enforces hierarchical compliance rules across distributed environments. The module may support enterprise-level global policies as well as local exceptions for specific device groups or operational clusters. Each policy may include conditional triggers and remediation workflows, allowing the system to autonomously apply corrective measures based on the nature and severity of non-compliance. The module 222 may further synchronize its policy definitions with other modules, such as the consensus module 214, to ensure consistent enforcement across the peer-to-peer network.

As described in the invention disclosure, the compliance management module 222 may also provide offline and autonomous remediation capabilities. When network connectivity is unavailable, endpoint agents may locally execute cached compliance rules validated by the compliance management module 222, allowing uninterrupted policy enforcement. The module may maintain a distributed compliance ledger capturing validation timestamps, policy versions, and remediation logs for each endpoint. Upon restoration of connectivity, these local compliance states may be synchronized with the global compliance repository to maintain system-wide consistency. This architecture ensures that enterprise policies remain enforceable even in fragmented or disconnected network conditions. In some embodiments, the compliance management module 222 may employ artificial intelligence and rule-based inference models to predict potential compliance drifts before they occur. The module may analyse historical deviations, behavioural trends, and configuration changes to forecast which endpoints are most likely to become non-compliant. Based on these predictions, the compliance management module 222 may pre-emptively schedule audits or push preventive configuration updates. The module may also rank detected non-compliances by impact severity, ensuring that critical security violations are prioritised for immediate remediation. In further embodiments, the compliance management module 222 may support multi-domain and cross-platform compliance management across diverse operating systems and enterprise infrastructures. It may integrate with regulatory frameworks such as ISO 27001, SOC 2, or NIST standards by mapping local configurations to global compliance controls. The compliance management module 222 may provide an interface for administrators to define custom compliance policies, import third-party compliance templates, or export audit-ready reports. In certain configurations, the module may coordinate with cloud compliance services to validate configuration conformity across hybrid and multi-cloud deployments.

In an embodiment, the communication interface 224 may be configured to facilitate encrypted peer-to-peer exchanges of task data, threat intelligence, and compliance information between the plurality of endpoint agents. The communication interface 224 may establish secure communication channels among peers within the mesh network and ensure confidentiality, integrity, and authenticity of transmitted data. It may support both synchronous and asynchronous communication protocols, allowing peers to exchange information in real time or through queued synchronization depending on network conditions. The communication interface 224 may utilize standardized encryption protocols such as TLS or AES for data transmission and may employ mutual authentication to prevent unauthorized node participation. In another embodiment, the communication interface 224 may manage secure session establishment and message routing within the peer-to-peer mesh network. It may negotiate cryptographic keys between peers, authenticate device identities, and handle the rekeying process when network topology changes occur. The communication interface 224 may also maintain routing tables that dynamically map communication paths between peers, ensuring minimal latency and efficient bandwidth utilization. By handling these low-level communication functions autonomously, the interface ensures stable and secure data exchange even in complex or high-latency environments. As detailed in the invention disclosure, the communication interface 224 may implement zero-trust access principles, ensuring that all peer interactions are verified, authenticated, and authorized on a per-transaction basis. The interface may integrate with distributed identity systems or local credential managers that store cryptographic tokens or digital certificates for authentication. Each message transmitted through the communication interface 224 may include a cryptographically signed header containing source, destination, and integrity metadata, enabling endpoint agents to validate the authenticity of every communication. The communication interface 224 may also apply dynamic encryption policies based on data sensitivity, allowing selective encryption levels for telemetry, task results, or configuration files.

In some embodiments, the communication interface 224 may support multi-protocol interoperability to enable seamless communication across hybrid network environments. It may encapsulate messages using TCP/IP, MQTT, WebSocket, or custom lightweight communication frameworks optimized for IoT and edge devices. The communication interface 224 may also detect the presence of secure VPN tunnels or SD-WAN overlays and dynamically route communication through the most secure or efficient path. In distributed enterprise configurations, the interface may further coordinate message queuing and compression to ensure reliable delivery even under intermittent connectivity conditions. In further embodiments, the communication interface 224 may be integrated with security and compliance frameworks to enforce enterprise-level communication policies. The module may log all data exchanges, store transmission metadata, and perform continuous anomaly monitoring to detect irregular communication patterns. It may also cooperate with the security intelligence module 218 to flag suspicious peer behaviour, isolate compromised nodes, or revoke communication credentials when necessary. Additionally, the interface may facilitate external connectivity between the peer-to-peer endpoint management system 108 and authorized third-party monitoring or orchestration platforms, using secure APIs or federated gateways.

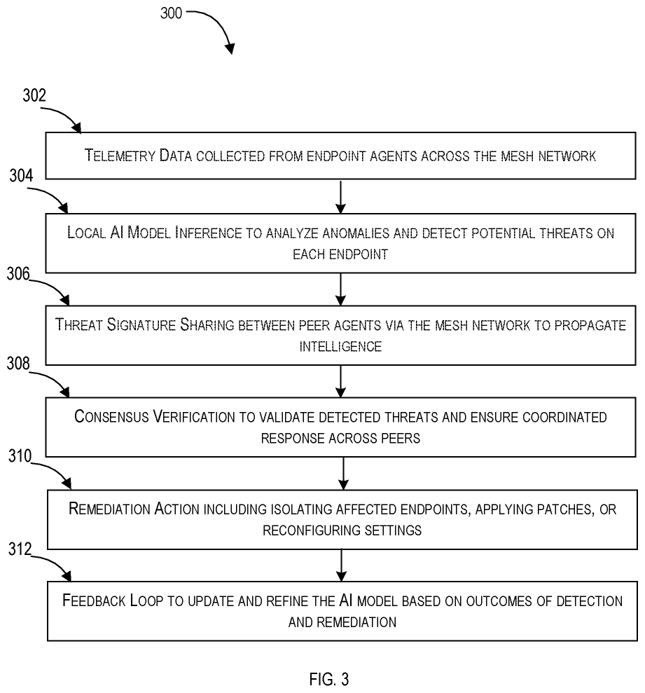

FIG. 3 illustrates a functional workflow 300 representing an exemplary process for security intelligence operations performed across endpoint agents within a mesh network, in accordance with an embodiment of the present disclosure. The workflow 300 depicts the logical sequence of operations executed cooperatively among distributed peers for anomaly detection, threat validation, and adaptive remediation using artificial-intelligence-based inference models.

At step 302, telemetry data may be collected from endpoint agents distributed across the mesh network. Such telemetry may include, without limitation, system performance metrics, event logs, process behaviours, file-access patterns, and network communication traces. The collected telemetry enables contextual understanding of each endpoint's operational state and forms the input dataset for subsequent local analysis. The data collection may occur continuously or at scheduled intervals, depending on system policy or resource availability.

Next, at step 304, local artificial-intelligence (AI) model inference may be performed to analyse the telemetry data and detect potential anomalies or threats at each endpoint. Each endpoint may execute its resident inference model to classify behavioural deviations, identify malware signatures, or detect suspicious execution sequences. The inference may use one or more AI techniques, such as neural-network-based classification, decision-tree analytics, or statistical deviation detection. The local inference allows real-time threat recognition even when external connectivity is unavailable, enabling distributed autonomy of each endpoint.

At step 306, the detected threat signatures or anomaly indicators may be shared between peer agents through the mesh network to propagate intelligence across the distributed environment. Each peer may broadcast its validated threat insights, enabling nearby endpoints to pre-emptively identify similar threats within their local context. The shared intelligence may include abstracted features, hashed signatures, or anonymised threat descriptors, ensuring that privacy and bandwidth efficiency are preserved. This cooperative exchange allows rapid dissemination of new threat knowledge without central coordination.

Next, at step 308, a consensus verification process may be executed among peer agents to validate detected threats and ensure coordinated response across the network. The peers may collectively confirm the authenticity and severity of the detected event through distributed voting or rule-based agreement. Only when consensus is reached are corresponding remediation tasks activated. This step ensures that false positives are filtered and that the collective network state remains consistent and verified before executing corrective actions.

At step 310, remediation actions may be initiated across affected endpoints. The remediation may include isolating compromised devices, applying relevant security patches, terminating malicious processes, restoring configurations, or enforcing temporary network restrictions. The process may be adaptive in nature, such that endpoints dynamically select the most appropriate remediation strategy based on threat classification, resource availability, and operational criticality. The distributed coordination ensures that all peers respond in a harmonised manner, preventing threat propagation and restoring compliance integrity.

Thereafter, at step 312, a feedback loop may be executed to update and refine the AI models based on the outcomes of detection and remediation activities. Each endpoint may record success metrics, false-positive rates, and remediation effectiveness, contributing anonymised learning data to improve future model performance. This iterative feedback mechanism enables continuous evolution of the detection models, ensuring that the overall system adapts to new attack vectors, environmental changes, and evolving enterprise security policies. Accordingly, the functional workflow 300 represents an intelligent, cooperative, and self-learning process for decentralised threat detection and mitigation within the peer-to-peer endpoint management ecosystem. By combining local inference, peer-to-peer intelligence sharing, consensus validation, and adaptive learning, the workflow ensures resilient, real-time, and autonomous security operations across distributed network environments.

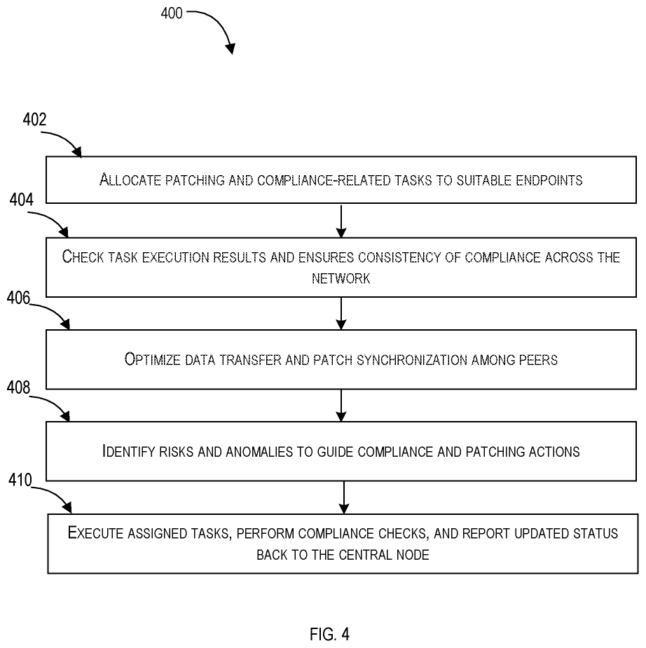

FIG. 4 illustrates a functional workflow 400 depicting an exemplary process for compliance management and patch orchestration across peer devices, in accordance with an embodiment of the present disclosure. The workflow 400 demonstrates how distributed endpoint agents cooperate within the peer-to-peer mesh network to maintain compliance integrity, allocate patching responsibilities, and execute updates efficiently without centralized dependency.

At step 402, patching and compliance-related tasks may be allocated to suitable endpoints within the mesh network. Each endpoint may be evaluated for parameters such as compute availability, operational priority, and network bandwidth before task assignment. The allocation may occur dynamically such that tasks are distributed among peers in proportion to their current capacity and resource utilization. This ensures balanced workload distribution and efficient patch execution across the network.

Next, at step 404, the task execution results may be verified to ensure consistency of compliance across the distributed endpoints. Each endpoint may validate its assigned operations and communicate execution outcomes with neighbouring peers for synchronization. The compliance state may then be reconciled across all participating nodes to confirm that patch applications, configuration corrections, and policy enforcements have been uniformly executed. This verification phase ensures that the collective compliance posture of the network remains accurate and consistent.

Next, at step 406, data transfer and patch synchronization among peers may be optimized to reduce bandwidth usage and latency. Patch packages or configuration updates may be propagated through peer-to-peer transmission instead of repeated downloads from external servers. Endpoints may share cached update files with nearby peers, enabling distributed patch dissemination and reducing redundant traffic. The synchronization schedule may adapt dynamically based on network congestion, link reliability, and endpoint proximity, ensuring that patches are propagated efficiently even in bandwidth-constrained environments.

Next, at step 408, risks and anomalies may be identified to guide compliance and patching actions. Each endpoint may analyse operational telemetry, task failures, or deviation patterns to detect early signs of non-compliance or vulnerability exposure. Detected anomalies may trigger risk classification and remediation prioritization, allowing the network to focus on critical vulnerabilities first. This analysis helps prevent re-emergence of non-compliant states and ensures that patch deployments directly address validated risks.

Thereafter, at step 410, the assigned tasks may be executed, compliance checks may be performed, and updated results may be reported back to a designated supervisory node or synchronization point within the network. Each endpoint may apply the required patches, validate compliance parameters, and transmit status summaries for consolidation. The reporting mechanism ensures that even in a decentralized system, global visibility of compliance posture and patch deployment progress is maintained. The final status may be stored for audit readiness and subsequent synchronization with enterprise management frameworks. Accordingly, the functional workflow 400 demonstrates an autonomous, distributed, and bandwidth-optimized process for managing compliance and orchestrating patches across peer devices. Through intelligent task allocation, coordinated verification, adaptive synchronization, and continuous feedback, the disclosed process enables scalable and self-regulating endpoint management across hybrid enterprise environments.

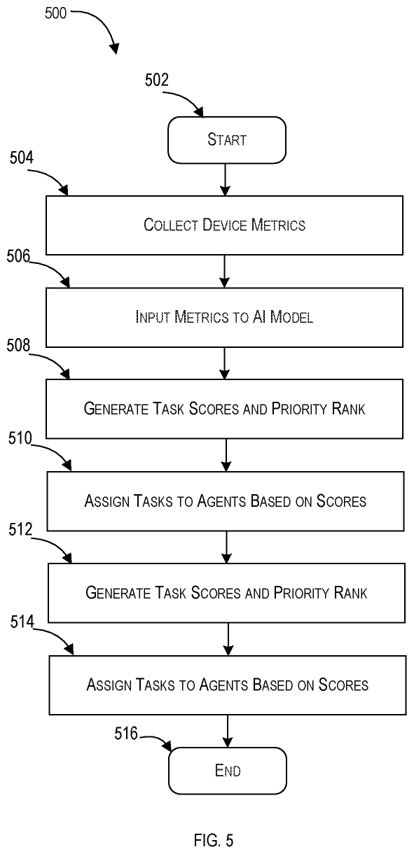

FIG. 5 illustrates a flowchart 500 of an exemplary AI-driven task allocation method for dynamically distributing operational tasks among endpoint agents, in accordance with an embodiment of the present disclosure. The method demonstrates how the peer-to-peer endpoint management framework intelligently evaluates device metrics, processes them through an AI model, and allocates tasks based on calculated priority rankings to achieve balanced and adaptive workload management across distributed endpoints. The method may begin at step 502, which represents the initiation of the task allocation process. This step may be triggered periodically, upon receiving a system event, or in response to a detected change in operational state or network conditions.

Next, at step 504, device metrics may be collected from the plurality of endpoint agents operating across the mesh network. These metrics may include hardware performance parameters such as CPU utilization, memory availability, input/output throughput, power consumption, and network bandwidth. Additionally, contextual indicators such as endpoint priority level, device role, and operational health status may also be gathered. The collected metrics provide the foundational dataset for assessing each endpoint's capability to execute upcoming operational tasks.

Next, at step 506, the collected metrics may be input into an AI model trained to evaluate resource conditions and predict optimal task distribution. The AI model may employ techniques such as regression analysis, reinforcement learning, or neural-network-based inference to determine each endpoint's current workload threshold and efficiency score. The model may continuously refine its predictions based on historical allocation outcomes and live telemetry feedback, ensuring that decisions adapt to evolving network and device conditions.

Next, at step 508, the AI model may generate task scores and corresponding priority ranks for each endpoint. The task score may represent a numerical evaluation of the endpoint's suitability for handling specific operational categories such as patching, compliance validation, or vulnerability scanning. The ranking may further incorporate dynamic factors such as time sensitivity, data locality, or previously assigned workload, thereby ensuring equitable and context-aware distribution across the peer network.

Next, at step 510, the generated scores may be used to assign tasks to individual endpoint agents. Endpoints with higher capacity and favourable task scores may receive larger or more complex assignments, whereas lower-scoring nodes may handle lightweight or deferred tasks. The assignment process may be executed in a distributed manner, allowing peers to negotiate or exchange roles depending on availability and latency. This ensures smooth orchestration and prevents over-burdening any single node within the network.

Next, at step 512, updated metrics may again be evaluated to verify whether workload conditions have changed following the initial allocation. Based on this re-evaluation, at step 514, the task scoring and prioritization process may be repeated, enabling real-time reallocation or balancing. This continuous optimization loop ensures that tasks remain proportionally assigned according to the most current performance and connectivity data. The system thereby achieves adaptive orchestration, allowing for self-healing task management when network states or device resources fluctuate. Finally, at step 516, the process may conclude once all operational tasks are distributed according to the computed rankings or when a predefined stability threshold is achieved. The resulting distribution map may be stored for future reference and used to train subsequent AI iterations, further improving allocation precision over time. Accordingly, the flowchart 500 illustrates an autonomous and intelligence-driven task allocation framework for peer-to-peer endpoint management. By continuously analysing device metrics, predicting optimal task distribution, and dynamically re-ranking endpoint suitability, the disclosed method ensures equitable workload distribution, efficient network utilization, and sustained performance across decentralized computing environments.

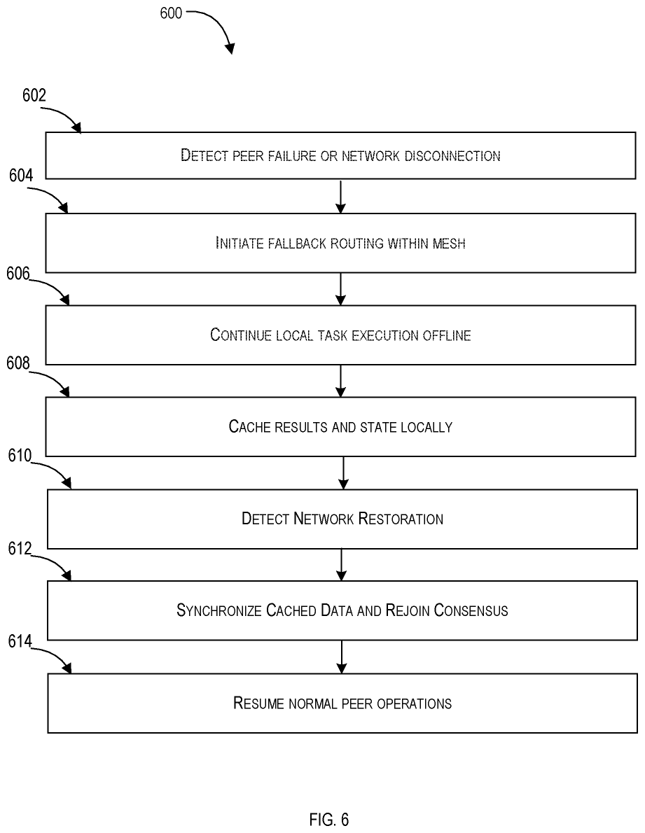

FIG. 6 illustrates a flowchart 600 of an exemplary self-healing and offline operation method enabling autonomous recovery and synchronization within the mesh network, in accordance with an embodiment of the present disclosure. The workflow 600 demonstrates how peer agents operating within a distributed mesh architecture autonomously handle connectivity failures, maintain local operation continuity, and rejoin synchronized consensus upon network restoration without centralized intervention.

At step 602, a peer failure or network disconnection may be detected. Each endpoint may continuously monitor the availability of its neighbouring peers and the integrity of network links. Detection may occur through heartbeat exchanges, latency thresholds, or timeout-based link status verification. Upon identifying a disconnection or unreachable peer, the network may initiate autonomous recovery measures to preserve continuity of operations.

At step 604, fallback routing may be initiated within the mesh network. The remaining active peers may reorganize their routing paths to bypass the disconnected node or reconfigure communication channels dynamically. The routing mechanism may employ shortest-path recalculation or alternate peer bridging to ensure uninterrupted message propagation and task coordination among the remaining endpoints. This adaptive routing preserves data flow and operational command dissemination across the decentralized environment.

At step 606, local task execution may continue in offline mode. Each endpoint may operate autonomously to perform scheduled or assigned tasks using cached data, locally available intelligence, and pre-defined execution rules. During this phase, the peers may rely on locally stored compliance policies, configuration templates, or AI models to maintain consistent functional behaviour even in isolation.

At step 608, task results, operational logs, and system states may be cached locally. The cache may include transactional updates, compliance verification outcomes, and task completion summaries, each time-stamped to support later synchronization. This ensures that no operational data or task outcome is lost while the endpoint remains disconnected. Local caching further enables accurate reconciliation when the network is re-established.

At step 610, network restoration may be detected. The endpoints may periodically probe network channels or receive broadcast signals indicating reconnection. Once connectivity is confirmed, the isolated peers prepare to rejoin the distributed consensus process by comparing cached states with the latest global mesh data.

At step 612, cached data may be synchronized, and the peer may rejoin the consensus framework. The system may validate cached logs, reconcile conflicting updates, and perform version alignment using distributed verification rules. Through this synchronization, endpoints restore uniform operational state across the network and ensure policy compliance consistency. The consensus realignment also verifies that the reconnected peer's cached tasks align with the collective execution record of the mesh.

Thereafter, at step 614, normal peer operations may resume. The reconnected peer may reinstate full participation in task orchestration, intelligence sharing, and policy enforcement activities within the mesh. Subsequent tasks may again be distributed seamlessly, and synchronization cycles may return to standard intervals. Accordingly, the flowchart 600 represents a resilient, autonomous, and fault-tolerant self-healing mechanism for decentralized endpoint management. By enabling offline continuity, adaptive rerouting, and intelligent consensus rejoining, the disclosed process ensures persistent functionality, minimal data loss, and rapid recovery from network failures across the peer-to-peer mesh environment.

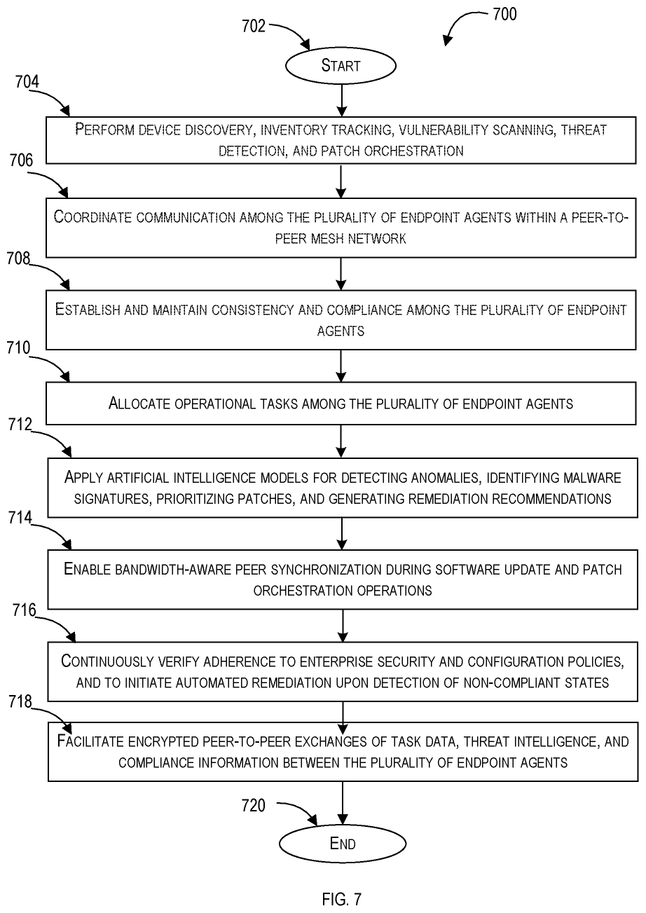

FIG. 7 illustrates a flowchart 700 of an exemplary method for decentralized endpoint management and security orchestration, in accordance with an embodiment of the present disclosure. The disclosed method may be executed cooperatively across multiple endpoint agents within a peer-to-peer mesh network to enable autonomous device management, real-time threat response, compliance maintenance, and bandwidth-optimized patch orchestration without reliance on centralized control systems. The method may commence at step 702, representing the initiation of decentralized management operations. The process may be triggered periodically, upon detection of a configuration change, or when a new endpoint joins the peer network.

At step 704, device discovery, inventory tracking, vulnerability scanning, threat detection, and patch orchestration may be performed by the plurality of endpoint agents. Each endpoint may independently identify connected devices, record hardware and software characteristics, and perform security or compliance assessments based on predefined baselines. Vulnerability scans may be executed to identify configuration deviations or unpatched software components, and patch orchestration may be initiated accordingly. This step establishes the foundational operational dataset for all subsequent management processes.

At step 706, communication may be coordinated among the plurality of endpoint agents within the peer-to-peer mesh network. Each endpoint may establish encrypted connections with neighbouring peers to exchange operational status, configuration data, or task-related information. Coordination may occur using decentralized message routing protocols, enabling secure and efficient synchronization of management activities across distributed endpoints.

At step 708, consistency and compliance may be established and maintained among the plurality of endpoint agents. Each peer may validate the task outcomes reported by others, cross-check compliance adherence, and ensure synchronization of configuration states. Consensus-based validation may be performed periodically to detect and correct inconsistencies, ensuring uniform enforcement of enterprise policies even in partially disconnected environments.

At step 710, operational tasks may be allocated among the plurality of endpoint agents. Allocation may be based on parameters such as compute power, resource availability, network bandwidth, and operational priority. The allocation process may dynamically adjust to changing environmental conditions, redistributing tasks when a node becomes overloaded, unavailable, or reconnected after disconnection.

At step 712, artificial intelligence models may be applied for detecting anomalies, identifying malware signatures, prioritizing patches, and generating remediation recommendations. The AI models may process telemetry data gathered from endpoints and evaluate potential threats based on behavioural deviations or historical risk patterns. The generated insights may guide the prioritization of patch deployments and automated corrective actions, thereby improving accuracy and response time.

At step 714, bandwidth-aware peer synchronization may be enabled during software update and patch orchestration operations. Endpoints may distribute update packages across the mesh network using peer-to-peer propagation rather than repeated downloads from centralized servers. The synchronization rate may adapt dynamically to available bandwidth, prioritizing critical updates while deferring non-essential transfers to reduce congestion.

At step 716, continuous verification of adherence to enterprise security and configuration policies may be performed. The method may further initiate automated remediation upon detection of non-compliant states. Each endpoint may regularly assess its compliance posture against predefined rules, trigger local corrections when necessary, and propagate policy status updates to neighbouring peers. Automated remediation may include actions such as applying patches, modifying configurations, or isolating non-compliant nodes until conformity is restored.

At step 718, encrypted peer-to-peer exchanges of task data, threat intelligence, and compliance information may be facilitated among the plurality of endpoint agents. All inter-peer communication may occur using cryptographically secured channels, ensuring confidentiality and authenticity of transmitted data. The exchange of threat intelligence and compliance reports enhances collective situational awareness, enabling peers to respond to emerging threats collaboratively and in real time. Finally, at step 720, the method may conclude once all tasks are executed, synchronized, and verified for compliance. The resulting data may be stored locally or synchronized with higher-level enterprise systems for audit readiness, reporting, or analytics. Accordingly, the flowchart 700 represents a comprehensive and adaptive method for decentralized endpoint management and security orchestration. By integrating AI-based detection, bandwidth-aware synchronization, distributed compliance verification, and encrypted peer collaboration, the method enables fault-tolerant, autonomous, and continuously self-optimizing endpoint management across heterogeneous enterprise environments.

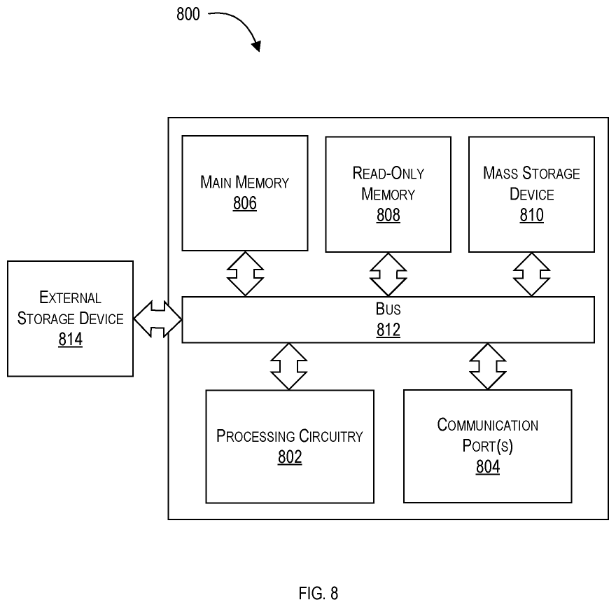

FIG. 8 illustrates an exemplary computing architecture 800 in which or with which a peer-to-peer endpoint management system may be implemented, in accordance with an embodiment of the present disclosure. Depending upon the implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, and/or firmware. As shown in FIG. 8, the computer system 800 includes an external storage device 814, a bus 812, a main memory 806, a read-only memory 808, a mass storage device 810, a communication port(s) 804, and a processing circuitry 802.

Those skilled in the art will appreciate that the computer system 800 may include more than one processing circuitry 802 and one or more communication ports 804. The processing circuitry 802 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quad-core, Hexa-core, or any suitable number of cores) or supercomputer. In some embodiments, the processing circuitry 802 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 802 include, but are not limited to, an Intel® Itanium® or Itanium 2 processor(s), AMD® Opteron® or Athlon MP® processor(s), Motorola® lines of processors, System on Chip (SoC) processors, or other future processors. The processing circuitry 802 may include various modules associated with embodiments of the present disclosure.

The communication port 804 may include a cable modem, an Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 804 may be any RS-232 port for use with a modem-based dialup connection, a 10/100 Ethernet port, a Gigabit, or a 10 Gigabit port using copper or fiber, a serial port, a parallel port, or other existing or future ports. The communication port 904 may be chosen depending on a network, such as a Local Area Network (LAN), Wide Area Network (WAN), or any network to which the computer system 800 may be connected.

The main memory 806 may include Random Access Memory (RAM) or any other dynamic storage device commonly known in the art. Read-only memory (ROM) 808 may be any static storage device(s), e.g., but not limited to, a Programmable Read-Only Memory (PROM) chips for storing static information, e.g., start-up or BIOS instructions for the processing circuitry 802.

The mass storage device 810 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 806. The mass storage device 810 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 812 communicatively couples the processing circuitry 802 with the other memory, storage, and communication blocks. The bus 812 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 802 to the software system.

Optionally, operator and administrative interfaces, e.g., a display, keyboard, and a cursor control device, may also be coupled to the bus 812 to support direct operator interaction with the computer system 800. Other operator and administrative interfaces may be provided through network connections connected through the communication port(s) 804. The external storage device 814 may be any kind of external hard drives, floppy drives, IOMEGA® Zip Drive, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The computer system 800 may be accessed through a user interface. The user interface application may be implemented using any suitable architecture. For example, it may be a stand-alone application wholly implemented on the computer system 800. The user interfaces application and/or any instructions for performing any of the embodiments discussed herein may be encoded on computer-readable media. Computer-readable media include any media capable of storing data. In some embodiments, the user interface application is client-server-based. Data for use by a thick or thin client implemented on an electronic device computer system 800 is retrieved on-demand by issuing requests to a server remote to the computer system 800. For example, computer system 800 may receive inputs from the user via an input interface and transmit those inputs to the remote server for processing and generating the corresponding outputs. The generated output is then transmitted to the computer system 800 for presentation to the user.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C, . . . , and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

What is claimed is:

1. A peer-to-peer endpoint management system configured for decentralized device management and security orchestration, the system comprising:
a plurality of endpoint agents, each deployed on a respective endpoint device and configured to perform one or more of: device discovery, inventory tracking, vulnerability scanning, threat detection, and patch orchestration;
an agent orchestration module configured to coordinate communication among the plurality of endpoint agents within a peer-to-peer mesh network, wherein each endpoint agent is operable as both a task sensor and an orchestrator node for local decision-making;
a consensus engine configured to establish and maintain consistency and compliance among the plurality of endpoint agents by validating task execution, result synchronization, and policy enforcement across the mesh network;
a task distribution module configured to allocate operational tasks among the plurality of endpoint agents based on one or more of: compute power, resource availability, network bandwidth, and operational priority;
a security intelligence module configured to apply artificial intelligence models for one or more of: detecting anomalies, identifying malware signatures, prioritizing patches, and generating remediation recommendations based on cooperative peer data;
a bandwidth optimization module configured to enable bandwidth-aware peer synchronization during software update and patch orchestration operations;
a compliance management module configured to continuously verify adherence to enterprise security and configuration policies, and to initiate automated remediation upon detection of non-compliant states; and
a communication interface configured to facilitate encrypted peer-to-peer exchanges of task data, threat intelligence, and compliance information between the plurality of endpoint agents;
wherein the peer-to-peer endpoint management system is operable to maintain operational continuity and coordinated defense across the plurality of endpoint devices even during network disconnection or server outages, thereby providing fault-tolerant, autonomous, and bandwidth-efficient endpoint management.

2. The peer-to-peer endpoint management system as claimed in claim 1, wherein the consensus engine is further configured to resolve conflicting task outcomes by performing a majority-vote validation among the plurality of endpoint agents to ensure uniform policy enforcement.

3. The peer-to-peer endpoint management system as claimed in claim 1, wherein the task distribution module employs a machine-learning-based scheduling algorithm trained on historical device performance metrics to predict optimal task assignments for subsequent operations.

4. The peer-to-peer endpoint management system as claimed in claim 1, wherein the security intelligence module is further configured to perform federated learning among the plurality of endpoint agents such that local threat-detection models are updated cooperatively without transferring raw telemetry data.

5. The peer-to-peer endpoint management system as claimed in claim 1, wherein the bandwidth optimization module dynamically adjusts peer synchronization frequency based on network congestion levels and available bandwidth thresholds to minimize update latency and data collisions.

6. The peer-to-peer endpoint management system as claimed in claim 1, wherein the compliance management module maintains a distributed compliance ledger recording configuration states and remediation timestamps across the plurality of endpoint devices for audit verification.

7. The peer-to-peer endpoint management system as claimed in claim 1, wherein the communication interface supports end-to-end encryption and zero-trust authentication, enabling secure peer discovery and message exchange without reliance on a centralized certificate authority.

8. The peer-to-peer endpoint management system as claimed in claim 1, wherein each of the plurality of endpoint agents is further configured to operate in an offline autonomous mode for a predefined duration by caching task queues and compliance policies until connectivity with the mesh network is restored.

9. A method for decentralized device management and security orchestration across a peer-to-peer mesh network, the method comprising:
deploying a plurality of endpoint agents on corresponding endpoint devices, each configured to perform one or more of: device discovery, inventory tracking, vulnerability scanning, threat detection, and patch orchestration;
coordinating communication among the plurality of endpoint agents within the peer-to-peer mesh network, wherein each endpoint agent operates as both a task sensor and an orchestrator node for local decision-making;
establishing and maintaining consistency and compliance among the plurality of endpoint agents by validating task execution, synchronizing results, and enforcing policies through a consensus process;
allocating operational tasks among the plurality of endpoint agents based on one or more of: compute power, resource availability, network bandwidth, and operational priority;
applying artificial intelligence models for detecting anomalies, identifying malware signatures, prioritizing patches, and generating remediation recommendations using cooperative peer data;
enabling bandwidth-aware peer synchronization during software update and patch orchestration operations;
verifying adherence to enterprise security and configuration policies and initiating automated remediation upon detection of non-compliant states; and
facilitating encrypted peer-to-peer exchanges of task data, threat intelligence, and compliance information between the plurality of endpoint agents;
wherein the method maintains operational continuity and coordinated defense across the plurality of endpoint devices even during network disconnection or server outages, thereby providing fault-tolerant, autonomous, and bandwidth-efficient endpoint management.

10. The method as claimed in claim 9, further comprises resolving conflicting task outcomes by performing a majority-vote validation among the plurality of endpoint agents to ensure uniform policy enforcement.

11. The method as claimed in claim 9, further comprises employing a machine-learning-based scheduling algorithm trained on historical device performance metrics to predict optimal task assignments for subsequent operations.

12. The method as claimed in claim 9, further comprises performing federated learning among the plurality of endpoint agents such that local threat-detection models are updated cooperatively without transferring raw telemetry data.

13. The method as claimed in claim 9, further comprises dynamically adjusting peer synchronization frequency based on network congestion levels and available bandwidth thresholds to minimize update latency and data collisions.

14. The method as claimed in claim 9, further comprises maintaining a distributed compliance ledger recording configuration states and remediation timestamps across the plurality of endpoint devices for audit verification.

15. The method as claimed in claim 9, further comprises supporting end-to-end encryption and zero-trust authentication, enabling secure peer discovery and message exchange without reliance on a centralized certificate authority.

16. The method as claimed in claim 9, wherein each of the plurality of endpoint agents is further configured to operate in an offline autonomous mode for a predefined duration by caching task queues and compliance policies until connectivity with the mesh network is restored.

17. A non-transitory computer-readable medium storing instructions that, when executed by one or more processors, cause a peer-to-peer endpoint management system to perform operations comprising:
deploying a plurality of endpoint agents on corresponding endpoint devices, each configured to perform one or more of: device discovery, inventory tracking, vulnerability scanning, threat detection, and patch orchestration;
coordinating communication among the plurality of endpoint agents within a peer-to-peer mesh network, wherein each endpoint agent operates as both a task sensor and an orchestrator node for local decision-making;
establishing and maintaining consistency and compliance among the plurality of endpoint agents by validating task execution, synchronizing results, and enforcing policies through a consensus process;
allocating operational tasks among the plurality of endpoint agents based on one or more of: compute power, resource availability, network bandwidth, and operational priority;
applying artificial intelligence models for detecting anomalies, identifying malware signatures, prioritizing patches, and generating remediation recommendations using cooperative peer data;
enabling bandwidth-aware peer synchronization during software update and patch orchestration operations;
verifying adherence to enterprise security and configuration policies and initiating automated remediation upon detection of non-compliant states; and
facilitating encrypted peer-to-peer exchanges of task data, threat intelligence, and compliance information between the plurality of endpoint agents;
wherein execution of the instructions maintains operational continuity and coordinated defense across the plurality of endpoint devices even during network disconnection or server outages, thereby providing fault-tolerant, autonomous, and bandwidth-efficient endpoint management.

18. The non-transitory computer-readable medium as claimed in claim 17, wherein the instructions further cause the system to resolve conflicting task outcomes by performing a majority-vote validation among the plurality of endpoint agents to ensure uniform policy enforcement.

19. The non-transitory computer-readable medium as claimed in claim 17, wherein the instructions further cause the system to employ a machine-learning-based scheduling algorithm trained on historical device performance metrics to predict optimal task assignments for subsequent operations.

20. The non-transitory computer-readable medium as claimed in claim 17, wherein the instructions further cause the system to perform federated learning among the plurality of endpoint agents such that local threat-detection models are updated cooperatively without transferring raw telemetry data.
